(19) United States
(12) Patent Application Publication
(10) Pub. No.: US 2007/0237861 A1
(43) Pub. Date: Oct. 11, 2007

(54) Method for Making and Using Sugar On snow and Product Resulting Therefrom

(76) Inventor: Stephen C. LaFlam, Hinsdale, NH (US)

Correspondence Address: LAW OFFICE OF MICHAEL A. BLAKE, 112 BROAD STREET, MILFORD, CT, 06460, US

(21) Appl. No.: 11/278,686

(22) Filed: Apr. 5, 2006

(51) Int. Cl. A23B 7/148; A23L 1/00; A23G 3/00

(52) U.S. Cl. 426/106; 426/302; 426/660

(57) ABSTRACT

A method for refining and bottling maple syrup for use in making sugar on snow, the method comprising: heating the maple syrup to about 22° F. to about 28° F. about the boiling point of water; bottling the heated maple syrup at a temperature above about 180° F.; and cooling the bottle maple syrup to about room temperature. The disclosed invention also relates to a method for preparing sugar on snow, the method comprising: warming bottled maple syrup to about 140° F.; and pouring the warmed maple syrup on a cold medium. The disclosed invention, in addition, relates to a bottled sugar on snow preparation prepared by the process comprising: heating the maple syrup to about 22° F. to about 28° F. about the boiling point of water; bottling the heated maple syrup at a temperature above about 180° F.; and cooling the bottle maple syrup to about room temperature.

### TECHNICAL FIELD

The field of invention relates to a method for bottling maple syrup, using the bottled maple syrup, and the product resulting there from, and more particularly to a method for bottling maple syrup such that sugar on snow can be prepared from the bottled maple syrup.

### BACKGROUND

Sugar on snow has been a traditional spring-time favorite in New England for over 200 years. In some areas of the maple region, sugar on snow is also known as “leather aprons” or “leather britches”, due to its chewy, leathery consistency. Normally sugar on snow is made during the maple season, which typical runs from about the end of February for approximately six weeks. Typically sugar on snow is made by heating maple syrup to about 22° F. to about 28° F. above the boiling point of water, which can be a messy, difficult process, since maple syrup typically boils at about 7° F. above the boiling point of water. As soon as the syrup reaches the proper temperature, it is poured or drizzled immediately, without stirring, over packed snow or shaved ice. Because the syrup cools so rapidly, the supersaturated solution does not have a chance to crystallize. It will form a thin glassy, chewy, taffy-like sheet over the snow whereupon people may eat the sweet treat with a fork or spoon.

There is a need for a sugar on snow product that can be made easily without the mess, danger, and inconvenience of heating maple syrup to above its boiling point.

### SUMMARY

The disclosed invention relates to a method for refining and bottling maple syrup for use in making sugar on snow, the method comprising: heating the maple syrup to about 22° F. to about 28° F. about the boiling point of water; bottling the heated maple syrup at a temperature above about 180° F.; and cooling the bottle maple syrup to about room temperature.

The disclosed invention also relates to a method for preparing sugar on snow, the method comprising: warming bottled maple syrup to about 140° F.; and pouring the warmed maple syrup on a cold medium.

The disclosed invention, in addition, relates to a bottled sugar on snow preparation prepared by the process comprising: heating the maple syrup to about 22° F. to about 28° F. about the boiling point of water; bottling the heated maple syrup at a temperature above about 180° F.; and cooling the bottle maple syrup to about room temperature.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a flow chart describing an embodiment of the disclosed process for bottling sugar on snow; and

FIG. 2 is a flow chart describing an embodiment of the disclosed process for preparing sugar on snow.

### DETAILED DESCRIPTION

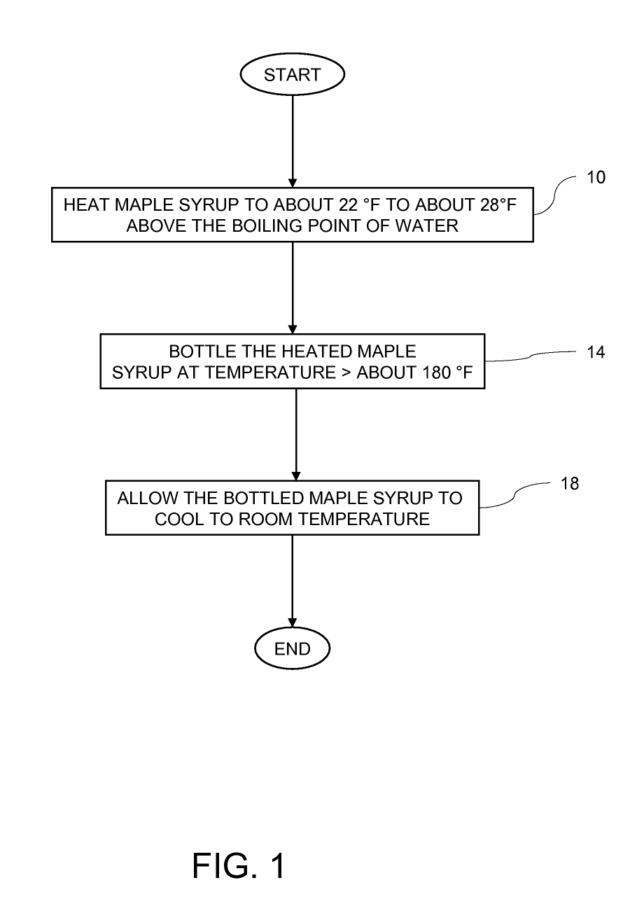

FIG. 1 is a flow chart describing an embodiment of the disclosed process for bottling sugar on snow. At act 10, maple syrup is heated to about 22° F. to about 28° F. above the boiling point of water. The maple syrup may be any standard maple syrup, that is with about 66% to about 67% sugar content. The disclosed process may be applied to other syrups of various sugar contents. At act 14, the heated maple syrup is bottled while maintaining a temperature of at least 180° F. At act 18 the bottled syrup is allowed to cool to room temperature, or any other suitable temperature to allow for boxing, shipping and or storage. The bottled syrup may be kept indefinitely at room temperature. Once opened, the bottled syrup should be refrigerated.

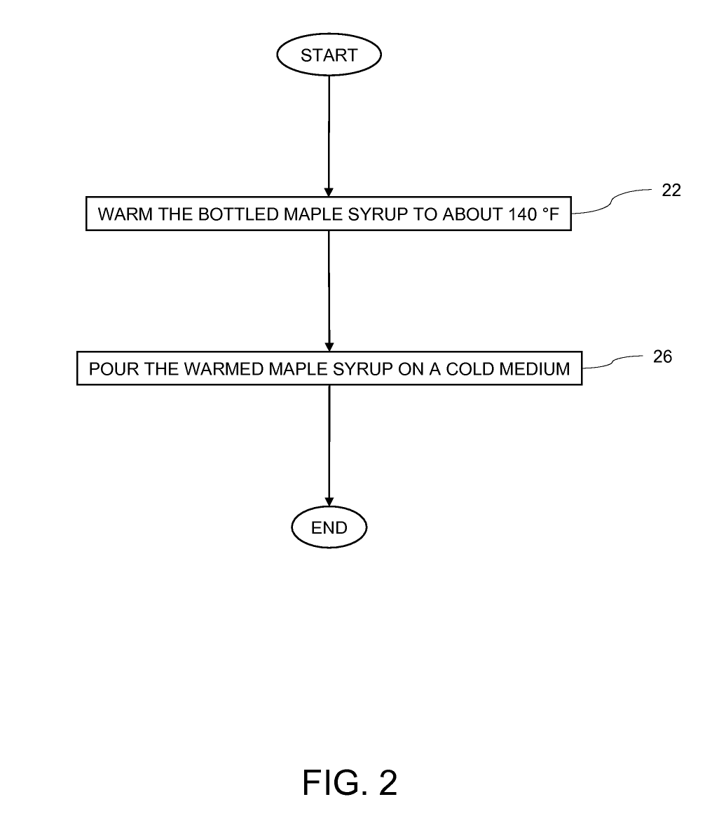

FIG. 2 is a flow chart describing an embodiment of the disclosed process for preparing sugar on snow. At act 22, the bottled maple syrup (prepared by the process disclosed above, also known as a “sugar on snow preparation”) is warmed to about 140° F. or any suitable temperature where the bottled maple syrup may be poured easily. Once the bottled maple syrup reaches the appropriate temperature, the maple syrup is poured onto a cold medium, such as, but not limited to: snow, ice, ice cream and frozen yogurt. When the warmed maple syrup is poured onto the cold medium, it cools down and begins to harden without crystallizing to a texture dependent on the sugar content of the maple syrup and can very from a generally taffy-like texture to a generally glass-like texture. This hardened maple syrup lying on a cold medium is known as sugar on snow.

The disclosed processes and product have many advantages. The sugar on snow desert can now be enjoyed throughout the year without the mess, inconvenience and danger of having to boil maple syrup to high temperatures. With the disclosed product, one merely needs to warm the bottled maple syrup and poor the warmed syrup onto a cold medium in order to enjoy the sugar on snow treat.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A method for refining and bottling maple syrup for use in making sugar on snow, the method comprising:
heating the maple syrup to about 22° F. to about 28° F. about the boiling point of water;
bottling the heated maple syrup at a temperature above about 180° F.; and
cooling the bottle maple syrup to about room temperature.

2. A method for preparing sugar on snow, the method comprising:
warming bottled maple syrup to about 140° F. ; and
pouring the warmed maple syrup on a cold medium.

3. The method for preparing sugar on snow of claim 2, wherein the cold medium is selected from the group consisting of snow, ice, ice cream, and frozen yogurt.
A bottled sugar on snow preparation prepared by the process comprising:
heating the maple syrup to about 22° F. to about 28° F. about the boiling point of water;
bottling the heated maple syrup at a temperature above about 180° F.; and
cooling the bottle maple syrup to about room temperature.
